(19) United States
(12) Patent Application Publication
(10) Pub. No.: US 2012/0066955 A1
(43) Pub. Date: Mar. 22, 2012

(54) Fishing Lure Having Fully Rotatable Shank

(76) Inventor: Richard E. Hrncir, Palmer, TX (US)

(21) Appl. No.: 13/226,924

(22) Filed: Sep. 7, 2011

Related U.S. Application Data
(60) Provisional application No. 61/384,343, filed on Sep. 20, 2010.

(51) Int. Cl. A01K 85/00

(52) U.S. Cl. 43/42

(57) ABSTRACT

A fishing lure includes a lure body and a shank coupled to the body through an opening in the lure body. The opening has a size and the shank is configured to enable the shank to freely rotate within the opening.

### CROSS-REFERENCE TO RELATED APPLICATIONS

Priority is claimed from U.S. Provisional Application No. 61/384,343 filed on Sep. 20, 2010 and incorporated herein by reference for all purposes.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of to fishing lures. More particularly, this invention relates to a fishing lure that includes lure body and a shank. The shank is movably coupled to the lure body so that it can rotate relative to the body. The lure body may be a slab or a jig that includes hooks and other features, including an attachment for, e.g., fishing line, a swivel, or other means of coupling a fishing line to the fishing lure. The shank may include spinners, beads, swivels, hooks, or other features.

2. Background Art

Slabs and jigs are well known types of fishing lures and are used to attract a variety of fish species. Slabs typically include one or more hooks attached to a slab body, which may be formed from a number of materials, including lead. Jigs typically have hooks partially embedded within a jig body, which may be formed from lead or another relatively dense material. Slabs known in the art generally have one or more hooks attached to the slab body, wherein the slab body is designed to mimic the size, coloring, and shape of a bait fish. Jigs known in the art generally include spinners or propellers to add desirable fish-attracting effects. The spinners or propellers are generally attached to a shank that is fixed relative to the slab body.

A representative example fishing lure known in the art is described in U.S. Pat. No. 7,743,549 issued to Troutman. Relevant features of the lure described in the foregoing patent include a hook having a bend adjacent a barb to define a rear end of the lure and a shank extending toward an opposite front end of the lure. A lure body is attached to a portion of the shank of the hook and a movable support member extends from the lure body toward the front end of the lure and generally away from the rear end of the lure. A movable member, such as a spinner blade or a propeller, is movably associated with the movable support member for moving during use of the lure to attract fish to the lure. The movable member is located forward of the lure body adjacent the front end of the lure. A line attachment member is located adjacent the body for securing a fishing line to the lure. The line attachment member is located between the rear end of the lure and the movable member. In a preferred embodiment, the line attachment member is provided by an eye of the hook that extends from the lure body.

There continues to be a need for improved fishing lures.

### SUMMARY OF THE INVENTION

A fishing lure according to one aspect of the present invention relates to slab and jig lures having a pivoting shank passing through the slab or jig body. The shank is pivotally attached to the body so that the shank can rotate up to and including 360 degrees with respect to the body. The rotation enables mimicking the behavior of certain types of bait species. The pivoting shank moves in a manner that attracts fish, particularly when the lure moves reciprocally in a vertical direction so that the shank repeatedly pivots in a direction that opposed the movement of the lure (slab or jig) body.

Other aspects and advantages of the invention will be apparent from the following description and the appended claims.

### BRIEF DESCRIPTION OF THE DRAWINGS

FIG. 1 shows an example slab lure according to the invention.

FIG. 2 shows an example jig lure according to the invention.

### DETAILED DESCRIPTION

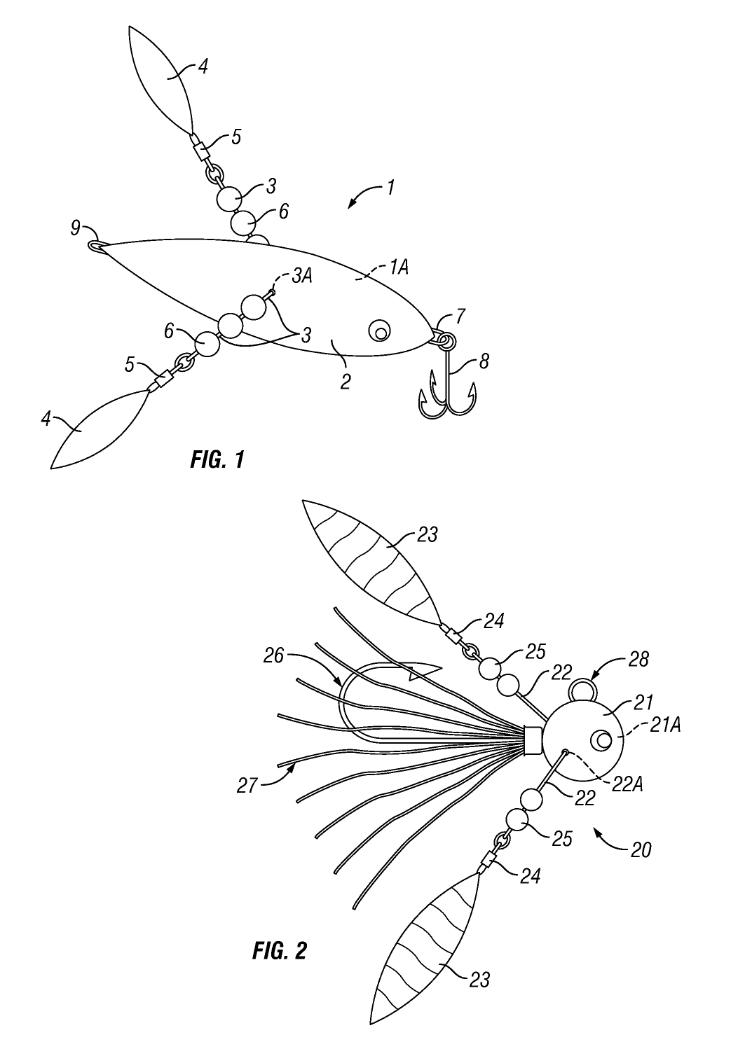

FIG. 1 shows an example slab lure. The slab lure 1 includes a slab body 2 with a line attachment loop 9 at one end. The line attachment loop 9 may be connected to, for example, a swivel or a fishing line. The slab body 2 further includes at least one hook attachment 7, which may be positioned at the end of the slab body 2 opposite the line attachment loop 9. At least one hook 8, which may be a treble hook, may be movably coupled to the hook attachment 7.

The example shown in FIG. 1 also includes a shank 3. In the present example, the shank 3 may have a bend proximate its midpoint, where the shank 3 passes through a suitably located opening 3A in the slab body 2. In the present example, the shank 3 is capable of rotating through a full 360 degrees relative to the slab body 2 so as to mimic the behavior of various bait species. The shank 3 may also include swivels 5, which are coupled to blades 4, spinners, or other devices designed to attract fish. The swivels 5 enable the blades 4 to rotate 360 degrees with respect to the shank 3. The shank 3 may further include additional attachments, including beads 6, a skirt (not shown), or other structures known in the art designed to mimic bait or to attract fish to the lure 1.

Further, the slab body 2 may include a coating 1A of types known to attract fish. For example, the coating 1A may comprise an epoxy suitable for underwater use. Moreover, the coating may include metallic flecks or glitter (neither shown separately) in various colors. Further, the coating 1A may also comprise a scent or other visual attractant designed to enhance the appeal of the lure 1 to fish.

Another example of a lure according to the invention is shown in FIG. 2. The example lure 20 in FIG. 2 comprises a jig-type body 21 coupled to a hook 26. The jig-type body 21 may be formed from lead or any other material suitable for use as a fishing lure. The jig-type body 21 comprises an attachment loop 28 that may be coupled to, for example, a swivel or a fishing line (not shown). The jig-type body 21 may also include a skirt 27 or other ornamentation attached on one side designed to mimic the behavior of bait species and to attract fish.

This example lure 20 further includes a shank 22 having a bend proximate its midpoint. The shank 22 passes through a suitably sized opening in the jig-type body 21. The shank 22 is capable of rotating a full 360 degrees relative to the jig-type body 21. The shank 22 may also include swivels 24 thereon, which are coupled to blades 23, spinners, or other devices designed to attract fish. The swivels 24 enable the blades 23 to rotate 360 degrees relative to the shank 22. The shank 22 may further include additional attachments, including beads 25, a skirt (not shown), or other structures known in the art to mimic bait or to attract fish to the lure 20.

Further, the jig-type body 21 may include a coating 21A of types known in the art to attract fish. For example, the coating 21A may comprise an epoxy suitable for underwater use. Moreover, the coating 21A may include metallic flecks or glitter (neither shown in FIG. 2) in various colors. Further, the coating 21A may also comprise a scent or other visual attractant designed to enhance the appeal of the lure to fish.

In the various examples of the invention shown in and explained above with reference to FIGS. 1 and 2, a shank passing through the lure body is configured to be able to freely rotate (i.e. through a full 360 degrees) with respect to the lure body. Such full rotation is believed to make a lure according to the invention more effective at attracting fish than lures not including such fully rotational shank.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fishing lure, comprising:
a lure body; and
a shank coupled to the body through an opening in the lure body, the opening having a size and the shank configured to enable the shank to freely rotate within the opening.

2. The lure of claim 1 wherein the lure body comprises a slab.

3. The lure of claim 1 wherein the lure body comprises a jig.

4. The lure of claim 1 wherein the shank comprises a bend disposed proximate a longitudinal center thereof.

5. The lure of claim 1 wherein the shank comprises at least one swivel thereon.

6. The lure of claim 5 wherein the swivel includes at least one of a blade or a spinner coupled thereto.

7. The lure of claim 1 further comprising a coating on the lure body.

8. The lure of claim 7 wherein the coating comprises epoxy.

9. The lure of claim 7 wherein the coating comprises a scent material.

10. The lure of claim 1 including at least one hook coupled to the lure body.

11. The lure of claim 1 wherein the lure body comprises lead.
